(19) United States
(12) Patent Application Publication
(10) Pub. No.: US 2008/0243738 A1
(43) Pub. Date: Oct. 2, 2008

(54) GAME DICTIONARIES

(75) Inventors: John Rieman, Helsinki (FI); Minna Hekanaho, Oulu (FI); Minna Koutonen, Oulu (FI); Tero Rantonen, Oulu (FI); John Hard, Malmo (SE)

Correspondence Address: PERMAN & GREEN, 425 POST ROAD, FAIRFIELD, CT, 06824, US

(73) Assignee: NOKIA CORPORATION, Espoo (FI)

(21) Appl. No.: 11/693,129

(22) Filed: Mar. 29, 2007

(51) Int. Cl. G06F 15/18

(52) U.S. Cl. 706/18

(57) ABSTRACT

A mobile communication apparatus including means for enabling the mobile communication apparatus for character input, comparing inputted characters with words in a list, prioritizing and listing matches of the comparison in a priority list depending on current context. Further, displaying the priority list, enabling selection from the displayed priority list and enabling updating of the list depending on current context. A corresponding application, apparatus, system, and computer program is also disclosed.

### TECHNICAL FIELD

The disclosed embodiments relate to methods for providing game dictionaries in a portable apparatus, a rendering application, a portable apparatus comprising a display and means for navigating, and a computer-readable medium having computer-executable components.

### BACKGROUND OF THE INVENTION

Communicating via text message services such as short message service (SMS), e-mail, instant messaging, etc., is very popular and plays an increasingly important role in our social life.

One popular way of communicating these text messages is by using some kind of communication device such as a mobile phone, a PDA, a palmtop computer, a personal computer, a handheld gaming device such as an Playstation Portable (PSP) or the Nokia N-gage, a gaming device such as Xbox, Xbox360, Playstation 3, Wii, etc.. However, entering text messages into these communication devices is often a cumbersome work. While some computing and communication devices, such as personal computers, palmtop computers, and some mobile phones have been equipped with a full QWERTY keyboard for alphanumeric text entry, many other computing, communication, and gaming apparatuses are only equipped with a limited or no keyboard. Text entering using a keyboard with a limited number of keys is often done by pressing a key a varying number of times, generally within a limited period of time, to input a specific letter. This technique is known as multi-tap. However, entering text with multi-tap or with a stylus is quite cumbersome for the user, especially if large quantities of text are going to be entered. Therefore, a number of text entering systems have been developed to facilitate and to speed-up the text entering. These systems, often referred to as single-tap system with predictive text technologies, uses predictive letter patterns to allow the user to enter text by press the keys as few times as possible.

The predictive text system uses a predictive text dictionary to “intelligently guess” which character(s) or word(s) the user is about to enter. The predictive text dictionary essentially contains a list of character strings, words, acronyms, abbreviations, etc. that is used to predict which word that is being entered by the user. When entering text using multi-tap or single-tap there may be several words that match a given keystroke(character)sequence. The predictive text system may then select the best match(es), i.e. making a priority list of matching words, based on information about word frequency in the used language or word frequency in the users idiolect.

The electronic gaming industry is growing rapidly and nowadays all kind of people, belonging to both sexes, in all age groups are playing electronic games (hereinafter referred to as games). Modern games are very sociable and are often played in groups consisting of people from around the world. Virtual worlds have been built where people can live an alternative life and make their dreams come true. Many people even meet there future husband or wife through games, so it is no question about it that games are becoming more and more important for a growing number of peoples social life. In most modern multiplayer games communication with other persons, both computer guided and humans, are very important to be able to advance in the game or to achieve some goal such as getting to the next level, finding an artifact, building a house, solving riddles, finding a partner, or just having fun. Most communications in these games are done via text messages as discussed above. To be able to successfully communicate with other players you must be able to use the right vocabulary in your text messages. This is crucial for the users successful integration into a gaming group or a gaming society.

### SUMMARY

In view of the above, it would be advantageous to solve or at least reduce the problems discussed above. In particular, it would be advantageous to provide a user friendly and efficient game dictionary for the predictive text system.

According to a first aspect of the disclosed embodiments, there is provided a method for a portable apparatus, comprising enabling said portable apparatus for character input, comparing inputted characters with words in a predictive text dictionary, prioritizing and listing matches of said comparison in a priority list depending on current context, displaying said priority list, enabling selection from said displayed priority list, and enabling updating of said list depending on said current context.

The method may comprise acquiring a special dictionary for use in said updating of said list.

The method may comprise communicating by wire or wirelessly with an external server via a network for acquiring said special dictionary.

The method may comprise storing said special dictionary via said network and retrieving said special dictionary from said external server.

According to a second aspect of the disclosed embodiments, there is provided a rendering application for a portable apparatus comprising a display, wherein said application cause enabling of said portable apparatus for

receiving at least one user inputted character,

comparing inputted characters with words in a list, prioritizing and listing matches of said comparison in a priority list depending on current context,

displaying said priority list,

enabling selection from said displayed priority list, and

enabling updating of said list depending on current context.

According to a third aspect of the disclosed embodiment, there is provided an apparatus arranged to receive a user input, wherein said user input comprise at least one character input, compare inputted characters with words in a list, a processor arranged to prioritize and list matches of an output of said comparator in a priority list depending on current context, wherein said display is arranged to, under control of said processor to display said priority list, and wherein said user input selection from said displayed priority list, wherein said processor is arranged to update said list depending on current context based on said selection.

According to a fourth aspect of the disclosed embodiments, there is provided a computer-readable medium having computer-executable components comprising instructions for enabling said portable apparatus for character input, comparing inputted characters with words in a list, prioritizing and listing matches of said comparison in a priority list depending on current context, displaying said priority list, enabling selection from said displayed priority list, and enabling updating of said list depending on current context.

According to a fifth aspect of the disclosed embodiments, there is provided a system comprising an apparatus according to the third aspect of the invention, and a dictionary server arranged to provide the associated dictionary for downloading. The system may comprise a communications network, wherein the dictionary server and the apparatus is in communication via the communications network.

According to a sixth aspect of the disclosed embodiments, there is provided a user interface in a portable apparatus comprising a display, and an input receiver, wherein said user interface is arranged to enable said portable apparatus for character input where said inputted characters are compared with words in a predictive text dictionary and matches of said comparison are listed in a list, and to display said list in said display.

The second, third, fourth, fifth and sixth aspects of the disclosed embodiments may be combined in any way with the features of the first aspect of the disclosed embodiments.

In the above description a renderer should be interpreted as a functional block applicable to any communication device, such as a mobile phone, capable of performing at least one of the following tasks; inputting, prioritizing, displaying, enabling, selecting, and updating.

Generally, all terms used in the claims are to be interpreted according to their ordinary meaning in the technical field, unless explicitly defined otherwise herein. All references to “a/an/the [element, device, component, means, step, etc]” are to be interpreted openly as referring to at least one instance of said element, device, component, means, step, etc., unless explicitly stated otherwise. The steps of any method disclosed herein do not have to be performed in the exact order disclosed, unless explicitly stated.

Other features and advantages of the disclosed embodiments will appear from the following detailed disclosure, from the attached dependent claims as well as from the drawings.

### BRIEF DESCRIPTION OF THE DRAWINGS

The above, as well as additional features and advantages of the disclosed embodiments, will be better understood through the following illustrative and non-limiting detailed description of preferred embodiments with reference to the appended drawings, where the same reference numerals will be used for similar elements, wherein:

FIG. 1 shows a mobile communication apparatus according to an embodiment;

FIG. 2 shows a flow chart describing a common character input process using a predictive text dictionary; and

FIG. 3 shows a display view of a handheld communication apparatus; and

FIG. 4 shows a flow chart describing a character input process using a predictive text dictionary and a special dictionary; and

FIG. 5 shows the storing of special dictionaries in the communication device and in a database on a server; and

FIG. 6 shows a display view of a handheld communication apparatus exemplifying an embodiment;

FIG. 7 schematically illustrates a system according to an embodiment;

FIG. 8 illustrates a computer readable medium according to an embodiment; and

FIG. 9 illustrates an exemplary user interface of the disclosed embodiments.

### DETAILED DESCRIPTION OF PREFERRED EMBODIMENTS

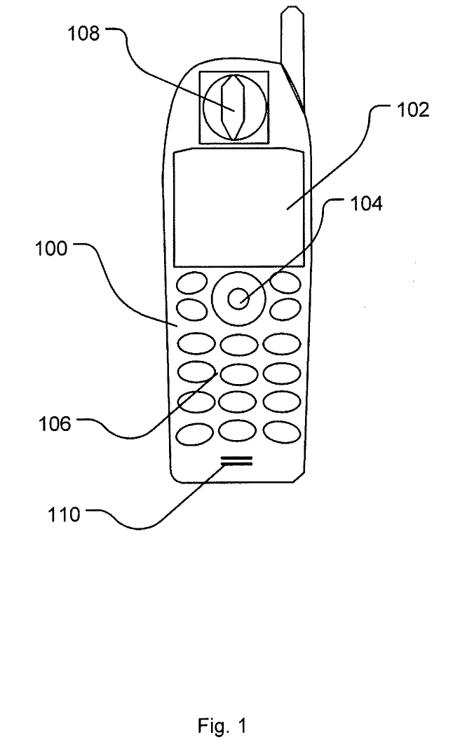

FIG. 1 shows a mobile communication apparatus 100 comprising a display 102 and means 104 for navigating among items (not shown) displayed in a display area 102. The navigation means 104 can be a rotating input, a joystick, a touch pad, but can also be implemented using a touch sensitive display, wherein the displayed items directly can be tapped by a user for selection, or be voice activated via a headset or a built-in microphone.

The mobile communication apparatus can also comprise other elements normally present in such an apparatus, such as a keypad 106, a speaker 108, a microphone 110, a processor (not shown), a memory (not shown), etc.

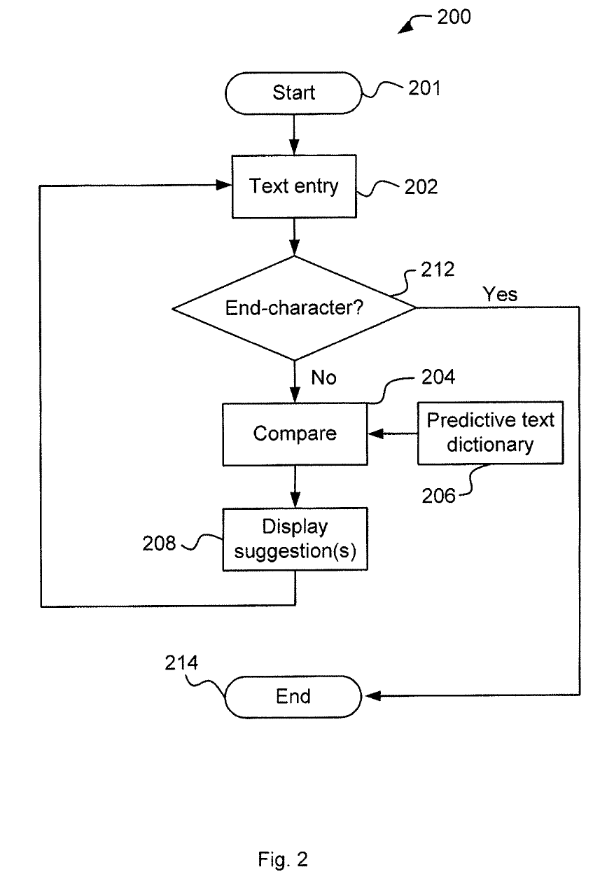

FIG. 2 shows a flow chart illustrating a common process of entering text in a communication device, such as a N-gage, Xbox360, and Playstation 3, with a predictive text system 200. The alphanumerical characters can be entered 202 using a stylus, writing or tapping the characters on the screen or on a dedicated area of the apparatus, or by using all or some of the keys on the communication apparatuses full or limited keyboard.

The last entered alphanumerical character is compared 212 with a predetermined and/or user configurable end-character such as a for example a ‘space’ character. If the entered 202 alphanumeric character is an end-character 212 the input of that specific character, group of characters, word, phrase, slang, abbreviation, etc. (hereinafter referred to as a word) is complete, and the text entry ends 214. If the user continues to enter alphanumerical characters after the end-character, i.e. begins to input a new word, the process restarts 201, else the user have entered all the words to complete a message and terminates the input process.

If no end-character is detected 212 the character entry is continued and the alphanumeric character, either by itself or in combination with other previous added characters forming a word or a part of a word, are compared in 204 with characters, words, phrases, abbreviations, slang, etc. stored in a predictive text dictionary 206. If one or several, complete or partial, matches between an entered word(s) 202 and words in the dictionary 206 are detected, they are made available, e.g. displayed on the screen of the communication apparatus as a list of suggestions, to the user 208. If several matches are found they are displayed in the suggestions list. The user is then able to choose any of the available words from the displayed suggestions list using the navigation means 104 mentioned in conjunction with FIG. 1. The character input process is continued 202 regardless of if the user chooses a word from the displayed list or continues to input characters. The input process continuous until an ‘end character’ is detected 212 or the character input is terminated by the user.

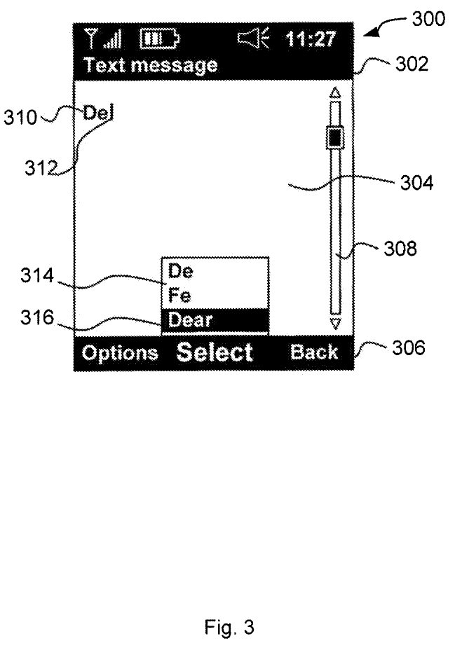

FIG. 3 illustrates an example of a common display view in a handheld communication apparatus 300, running a predictive text system, comprising a general status indication section 302, a softkey bar 306 and a general display area 304. The general status indication section 302 can for example include symbols for battery status, reception quality, speaker on/off, present mode, clock time, etc. The status indication section is not in any way limited to only include these symbols. Thus, other symbols in any shape, form or color can occur. The softkey bar 306, situated at the bottom of the display view, is operable using the navigation means 104 mentioned in conjunction with FIG. 1. The functions of these softkeys are not limited by the functions indicated in the figure.

The preferred function of the general display area 304, residing between the status indication section 302 at the top and the softkey bar 306 at the bottom, is to display information from running applications in the handheld communication apparatus. In our case the display area 304 also comprise a scroll bar 308, a suggestion list 314, inputted characters 310, and a cursor 312 showing where next character, word, phrase, abbreviation, etc. can be inputted.

FIG. 3 shows an example of how a common predictive text system, such as described in FIG. 2, operates. A user has entered the characters ‘D’ and ‘e’ 310 which together with a cursor 312 is shown at the top of the display views display area 304. The last entered character is ‘e’ which in this case is not an end-character. The two characters ‘D’ and ‘e’ forms the word ‘De’ which is compared against the words and the letter combinations stored in the predictive text dictionary. Several matches are found and they are displayed to the user in a suggestion list 314. The displayed suggestions are ‘De’, ° Fe‘, and ‘Dear’ where ‘De’ is rated the most likely word (highest priority) and therefore displayed first in the list. ‘Fe’ is rated second most likely (priority 2) and ‘Dear’ rated third most likely (priority 3). Since the user in this example wants to enter the word ‘Dear’, the user have to navigated amongst the suggestions down to the suggestion ‘Dear’, indicated by the black cursor bar 316. The user selects ‘Dear’ by operating ‘Select’ in the soft menu and ‘De’ is replaced by ‘Dear’ 318 as shown in the figure. The user can continue to enter characters, for example a ‘s’ to complete the word ‘Dears’ or enter a ‘space’, indicating that the word is complete and a new word is going to be entered, thus restarting the inputting and prediction process as described in conjunction with FIG. 2.

To be able to reduce the problem of communicating amongst gamers in a gaming community the predictive text dictionary must be updatable with special dictionaries connected to a specific game, a specific level in a game, artifacts in a game, call names/signs, events and quests, etc. This will provide the users with a tool for more effectively communicating with each other and strengthening the groups social bonds and thereby enhance the gaming.

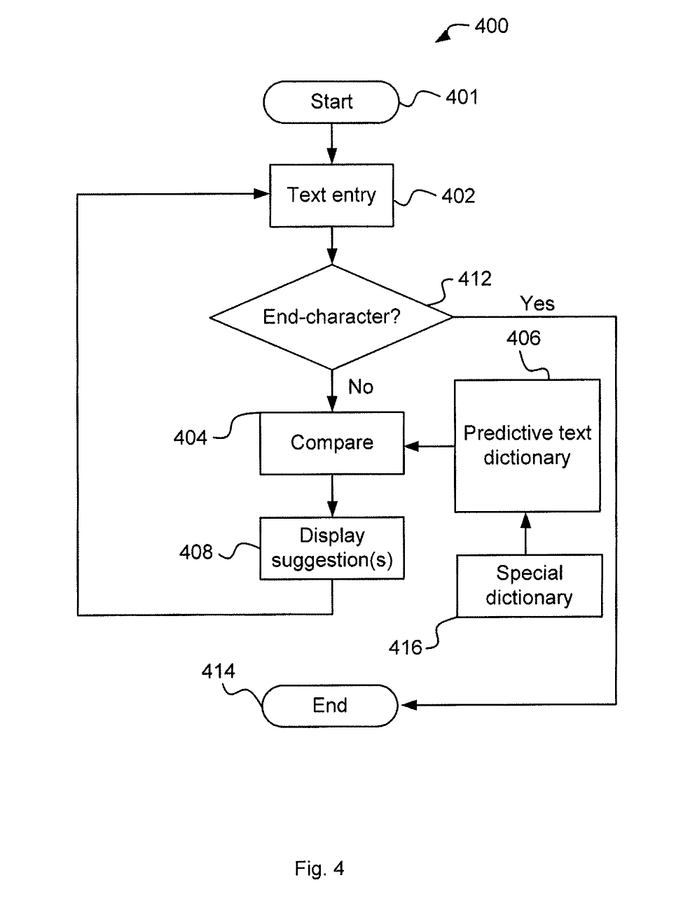

FIG. 4 shows a flow chart illustrating an embodiment comprising a process of entering text in a communication device, such as a mobile phone, with a predictive text system 400. The alphanumerical characters can be entered 402 using a stylus, writing or tapping the characters on the screen or a dedicated area of the apparatus, or by using all or some of the keys on the communication apparatuses full or limited keyboard.

The last entered alphanumerical character is compared 404 with a predetermined or user configurable end-character such as for example a ‘space’ character. If the entered 402 alphanumeric character is an end-character 412 the input of that specific character, characters, word, phrase, slang, abbreviation, etc. is completed and the text entry is ended 414. If the user continues to enter alphanumerical characters after the end-character, i.e. begins to input a new word, the process restarts 401, else the user have entered all the words to complete a message and terminates the input process.

If no end-character is detected 412 the character entry is continued and the alphanumeric character, either by itself or in combination with other previous added characters forming a word or a part of a word, are compared in 404 with characters, words, phrases, abbreviations, slang, etc. stored in the predictive text dictionary 406.

If one or several, complete or partial, matches between an entered character or word(s) 402 and words in the predictive text dictionary 406 are detected, they are made available, e.g. displayed on the screen of the handheld communication apparatus as a list of suggestions 408, to the user. Multiple matches are displayed in the suggestions list in a prioritized order with the most likely at the top of the list. Words that are never or seldom used by a user in a gaming environment, words that in a specific gaming context is unlikely to be chosen, and words that in a gaming context is deemed inappropriate words can be made to (user configurable) not appear in the suggestion list 408, thus making the list considerably shorter. Suggestions displayed in the suggestion list 408 can also be highlighted in different way to signal to the user that the specific suggestion differs in some way from other suggestions. Words can also be prioritized differently depending in what gaming context the user currently is in. These measures will speed-up the selection process considerably since the user does not have to navigate a long suggestions list 418 to find the correct word. Optimally the wanted word is always displayed at the top of the suggestion list. The user is then able to choose any of the available words from the displayed suggestions list using the navigation means 104 mentioned in conjunction with FIG. 1. The text input process is continued 402 regardless of if the user chooses a word from the displayed suggestion list 408 or just continues to input new characters 402. The input process continuous until an ‘end character’ is detected 412 or the text entry is terminated by the user.

The predictive text dictionary 406 is updatable with special dictionaries 416 depending on the current game and gaming context. New special dictionaries based on the game context can be downloaded by the user or done automatically during or after the game play. The special dictionary can either be added to, replacing, or merged (resulting in the union of both) 416 with the predictive text dictionary currently active. For instance, when a gamer have completed a level in the game a new special dictionary can be downloaded or is uploaded to the user containing new words for communicating with other players. Also, when a group of gamers enters a new level in a game and begins a new quest a special dictionary can be downloaded or is uploaded to the user containing new words connected to the quest (names of heroes, places, artifacts, spells, etc.), which the group will use when communicating with each other. The special dictionary can be downloaded/uploaded using a wireless or wired connection to a gaming server.

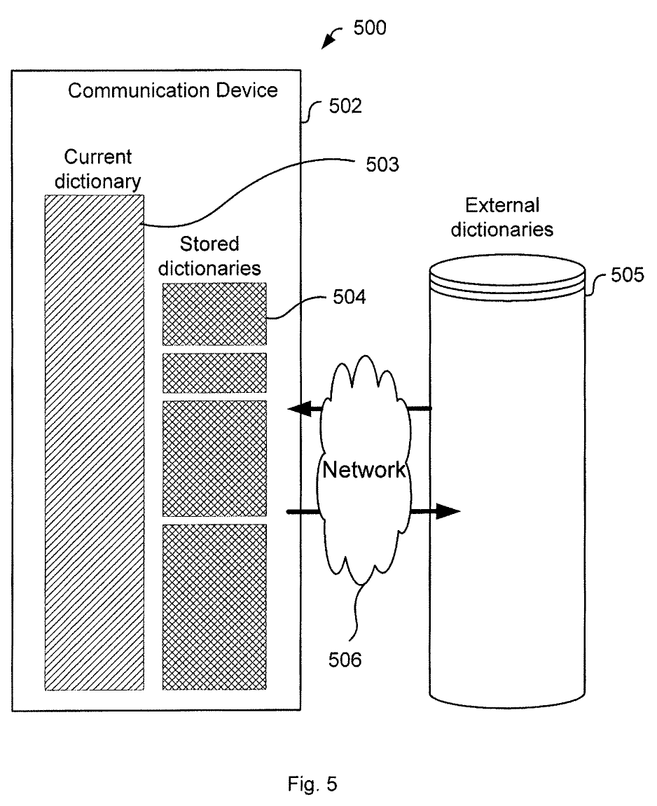

The communication device 500 in FIG. 5 may have, depending on available storage, one or more dictionaries stored 504 and operating in the devices memory 502 at one time. If the storage size in the device is large, a standard dictionary 503 (hereinafter called a full dictionary) together with several smaller special gaming dictionaries 504 can be stored in the device at the same time. If the storage size is small, a reduced full dictionary or only one or more special dictionaries 504 may be stored at the same time in the device. If the storage size is small it is important that the dictionary in the device is tailored to the user so no unnecessary words (i.e. words never or seldom used by the user) in the dictionaries take up valuable storage space.

The full dictionary 503 stores a multitude of character combinations and words from every possible subject while a special gaming dictionary focus gaming language used in different games. A special dictionary 504 can for instance be a dictionary with words connected to a specific game, a level in a game a quest, names on heroes and villains in a game, etc.. Special dictionaries can also be customized to comprise words not appropriate for a specific game. A special dictionary can be set to expire at a certain point in time, when the user moves up a level in a game, when the user haven‘t paid for the game any more, when the user changes game, etc.. It can also be set to expire after a certain amount of time, on a specific date, or after running a certain application a specific number of times, or when the memory is full and another dictionary downloaded to the device. This avoids that the dictionary becomes irrelevant.

As discussed above the internally stored dictionaries 502, can if wanted, be in constant change depending on the users change in gaming context etc.. To be able to safely store and to migrate the dictionaries to other communication devices the dictionaries can be sent 506 to an external storage (such as a dedicated gaming server) for safekeeping. This will also save precious internal storage 502 in the communication device since not all special gaming dictionaries are needed to be stored internally.

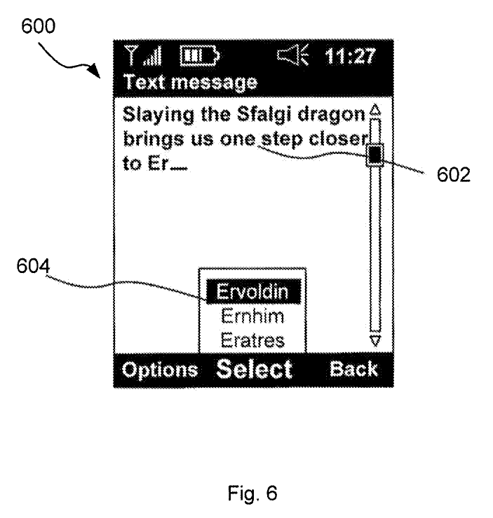

FIG. 6 shows a display view 600 of an embodiment. A gaming user playing a multiplayer role-playing game on his communication device has just killed a dragon with his gaming friends. The display view 600 shows how the user have entered a text message 602 saying ‘Slaying the Sfalgi dragon brings us one step closer to Er’. Since a special gaming dictionary belonging to the current level in the game he is playing have been automatically uploaded into the device, he gets three suggestions displayed in the suggestions list 604 namely ‘Ervoldin’, ‘Ernhim’, and ‘Erates’. The user can with confidence enter the name ‘Ervoldin’ without making a fool of him self misspelling or remembering the wrong name.

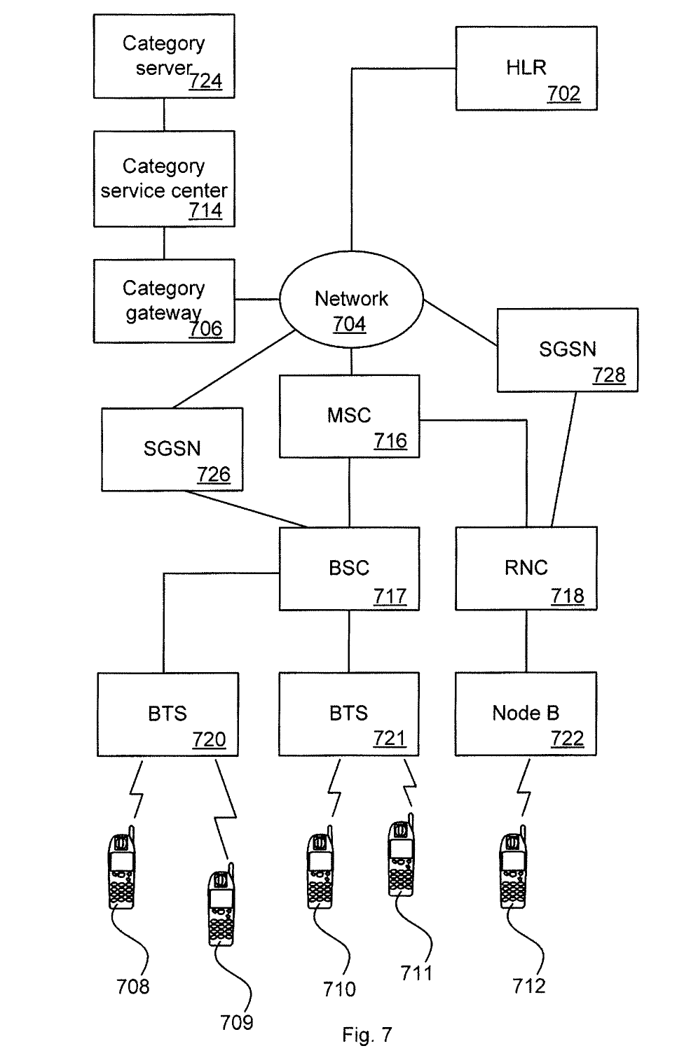

A system architecture for managing a system 700 according to an embodiment is shown in FIG. 7. A Home Location Register (HLR) 702 contains a database (not shown) including relevant subscriber information for provision of telecommunication service. A International Telecommunication Union (ITU) specified network 704 interconnects the individual parts of the system 700. A category gateway 706 is a switching unit routing a requested category to a mobile communication apparatus 708-712. A Category Service Center 714 (DSC) and the category gateway 706 handle and routes the categories between the DSC 714 and the network 704. From the network 704, the categories are routed to the handheld communication devices 708-712 via a Mobile Switching Center (MSC) 716 to a Base Station Controller (BSC) 717 and a Base Transceiver Station (BTS) 720, 721, or a Radio Network Controller (RNC) 718 and a Node B 722. Alternatively, the categories are routed to the handheld communication devices 708-712 via a Serving GPRS Support Node (SGSN) 726, 728 to the BSC 717 and the BTS 720, 721, or the RNC 718 and the Node B 722, respectively. The BTS 720, 721 or the Node B 722 establish the air connection to the handheld communication devices 708-712.

According to an embodiment, a network operator or other third party company, for example the provider of the application, handling a category server 724 could offer a category service function where dictionaries associated with certain applications can be purchased. For example a network operator may have a dictionary server 724 supporting a feature where the user may send a category request from his handheld communication devices 708-712 to the category server 724 upon using a certain application of the handheld communication devices, e.g. a gaming or messaging application.

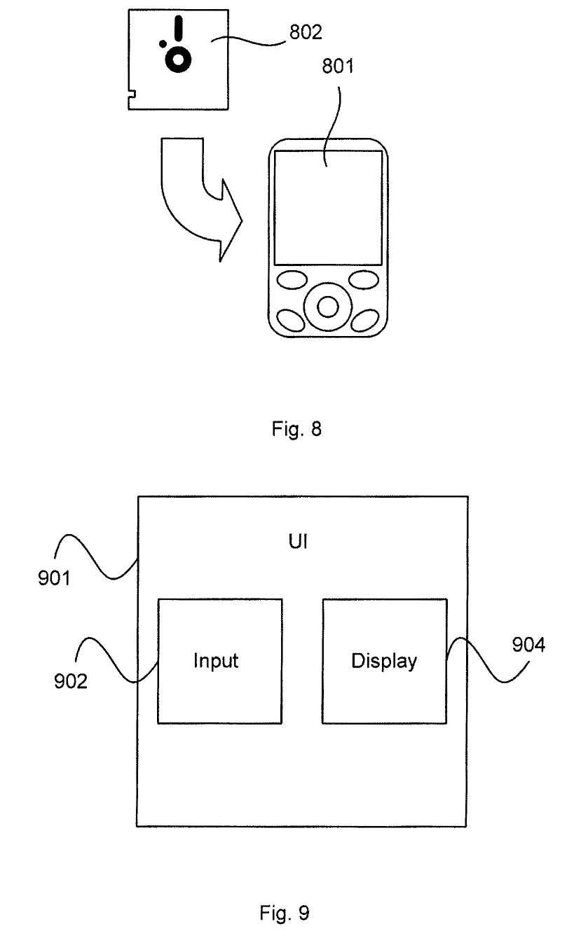

The invention can be computer-implemented, i.e. the media handling is performed on a general or dedicated computerized apparatus 801, such as a personal computer, a mobile phone, a digital camera, a personal digital assistant, a media player, or other similar apparatus. Instructions for performing the invention can then be executed by the apparatus. These instructions can be loaded into the apparatus 801 from a computer-readable medium 802, as exemplary illustrated in FIG. 8, having a data structure stored. The data structure comprises the control instructions, which upon execution causes the apparatus to perform any of the disclosed embodiments as described above.

FIG. 9 illustrates a user interface (UI) 901 in a portable apparatus having an input interface 902, which as described in above embodiments can be actuated by a user, and a display interface 904 for displaying information to the user as described in the above embodiments.

While the disclosed embodiments have been described with specificity to handheld communication devices, other types of computing devices with which the embodiments can be used will occur to those skilled in the art. For example, a personal computer can benefit from the invention in the same manner as the handheld communication device. Further, while the illustrated embodiments discusses the use of user-configurability, the user-configurability may be implicit or provided in some other manner than described above. The above-described embodiments of the invention are intended to be examples of the invention and alterations and modification may be affected thereto, by those skilled in the art, without departing from the scope of the invention, which is defined solely by the claims appended hereto.

1. A method for a portable apparatus, comprising:
enabling said portable apparatus for character input; comparing inputted characters with words in a predictive text dictionary; prioritizing and listing matches of said comparison in a priority list depending on current context; displaying said priority list; enabling selection from said displayed priority list; enabling updating of said list depending on said current context.

2. The method according to claim 1, further comprise acquiring a special dictionary for use in said updating of said list.

3. The method according to claim 2, further comprising communicating by wire or wirelessly with an external server via a network for acquiring said special dictionary.

4. The method according to claim 3, storing said special dictionary via said network and retrieving said special dictionary from said external server.

5. A rendering application for a portable apparatus comprising a display, wherein said application cause enabling of said portable apparatus for;
receiving at least one user inputted character;
comparing inputted characters with words in a list; prioritizing and listing matches of said comparison in a priority list depending on current context;
displaying said priority list;
enabling selection from said displayed priority list; and
enabling updating of said list depending on current context.

6. The application according to claim 5, further arranged to acquire a special dictionary for use in said updating of said list.

7. The application according to claim 6, further arranged to communicate by wire or wirelessly with an external server via a network for acquisition of said special dictionary.

8. The application according to claim 7, storing said special dictionary via said network and retrieving said special dictionary from said external server.

9. An apparatus comprising a display and a comparator arranged to receive a user input, wherein said user input comprise at least one character input, compare inputted characters with words in a list, a processor arranged to prioritize and list matches of an output of said comparator in a priority list depending on current context, wherein said display is arranged to, under control of said processor to display said priority list, and wherein said user input selection from said displayed priority list, wherein said processor is arranged to update said list depending on current context based on said selection.

10. The apparatus according to claim 9, further comprising a renderer for acquiring a special dictionary for use in said updating of said list.

11. The apparatus according to claim 10, further comprising a renderer capable of communicating by wire or wirelessly with an external server via a network.

12. The apparatus according to claim 11, further comprising a renderer, wherein said special dictionaries are stored and retrieved from said external server by said wire or wireless communication.

13. A computer-readable medium having computer-executable components comprising instructions for
enabling said portable apparatus for character input, comparing inputted characters with words in a list, prioritizing and listing matches of said comparison in a priority list depending on current context, displaying said priority list, enabling selection from said displayed priority list, and enabling updating of said list depending on current context.

14. The computer-readable medium according to claim 13, further comprising instructions for acquiring a special dictionary for use in said updating of said list.

15. The computer-readable medium according to claim 14, further comprising instructions for a portable apparatus capable of communicating by wire or wirelessly with an external server via a network.

16. The computer-readable medium according to claim 15, further comprising instructions for storing said special dictionary via said network and retrieving said special dictionary from said external server.

17. A system comprising an apparatus and a dictionary server
wherein said apparatus comprises a memory storing a set of instructions, and a processor, executing the stored set of instructions, to perform a method comprising
determining an application to be executed;
determining a dictionary associated to said determined application; and
enabling said associated dictionary, and
said dictionary server is arranged to provide the associated dictionary for downloading.

18. The system according to claim 17, further comprising a communications network, wherein the dictionary server and the apparatus is in communication via the communications network.

19. A user interface in a portable apparatus comprising a display, and an input receiver, wherein said user interface is arranged to enable said portable apparatus for character input where said inputted characters are compared with words in a predictive text dictionary and matches of said comparison are listed in a list; display said list in said display.
